(19) United States
(12) Patent Application Publication
(10) Pub. No.: US 2025/0139153 A1
(43) Pub. Date: May 1, 2025

(54) MULTI-MODAL KNOWLEDGE-BASED CONVERSATION DATA GENERATION AND ADDITIONAL INFORMATION LABELING SYSTEM

(71) Applicant: Korea Electronics Technology Institute, Seongnam-si (KR)

(72) Inventors: San KIM, Seongnam-si (KR); Sa Im SHIN, Seoul (KR); Jin Yea JANG, Seongnam-si (KR); Byung Gill JOE, Seongnam-si (KR)

(73) Assignee: Korea Electronics Technology Institute, Seongnam-si (KR)

(21) Appl. No.: 18/927,089

(22) Filed: Oct. 25, 2024

(30) Foreign Application Priority Data
Oct. 26, 2023 (KR) 10-2023-0144279

(51) Int. Cl. G06F 16/432; G06F 40/35

(52) U.S. Cl. CPC G06F 16/434; G06F 40/35

(57) ABSTRACT

There is provided a multi-modal knowledge-based conversation data generation and additional information labeling system. A conversation data generation method according to an embodiment includes: receiving input of a user utterance; searching pieces of text knowledge related to the user utterance; searching images related to the user utterance; receiving input of an answer to the user utterance referring to the searched text knowledge and images; and collecting the user utterances, the pieces of text knowledge, the images, and the answer to the user utterances as conversation data. Accordingly, open domain knowledge-based conversation data may be established by using both images and texts, and an image may be used as utterance and information acquired from the image may be used as utterance, so that AI conversation data similar to actual conversations can be established.

### CROSS-REFERENCE TO RELATED APPLICATION(S) AND CLAIM OF PRIORITY

This application is based on and claims priority under 35 U.S.C. § 119 to Korean Patent Application No. 10-2023-0144279, filed on Oct. 26, 2023, in the Korean Intellectual Property Office, the disclosure of which is herein incorporated by reference in its entirety.

### BACKGROUND

### Field

The disclosure relates to artificial intelligence (AI) conversation model development, and more particularly, to a method for generating conversation data for using as training data of an AI conversation model, which performs a conversation based on multi-modal knowledge, and for labeling additional information.

### Description of Related Art

FIGS. 1A to 1C are views illustrating a related-art open domain knowledge-based conversation collection tool. When a topic is selected, knowledge candidates to reference are displayed in the unit of a sentence, and knowledge to reference is selected only from the displayed sentences and an answer is created. That is, there is a limit to selecting knowledge.

In addition, the purpose of related-art knowledge-based conversation systems is mostly to provide a function of facilitating text-based open domain conversation collection, and hence, it is impossible to collect image knowledge-based conversation data therefrom.

Furthermore, related-art coreference resolution labeling is limited only to texts, or in the case of image-text cross-reference, labeling is limited to the coreference resolution on one image sheet and utterances.

### SUMMARY

The disclosure has been developed in order to solve the above-described problems, and an object of the disclosure is to provide a conversation data collection system and method which establishes open domain knowledge-based conversation data using both an image and a text, and supports coreference resolution labeling between all images and texts which are used in a conversation.

According to an embodiment of the disclosure to achieve the above-described object, there is provided a conversation data collection method including: searching pieces of text knowledge related to a user utterance; searching images related to the user utterance; and collecting the user utterance, the pieces of text knowledge, the images, and an answer to the user utterance as conversation data.

Searching the pieces of text knowledge may include: searching text documents related to the user utterance; selecting some of the searched text documents; selecting some of the pieces of text knowledge within the selected text document; and finally selecting text knowledge to reference for the answer to the user utterance among the selected pieces of text knowledge, and collecting may include collecting, as the conversation data, the user utterance, a query used for searching documents, the text knowledge finally selected to reference for the answer to the user utterance, and the answer to the user utterance.

The user utterance may be inputted by a developer who performs a role of a user having a conversation with an AI conversation model, and the answer to the user utterance may be inputted by a developer who performs a role of the AI conversation model.

Searching the images may include: searching the images related to the user utterance; and selecting images to use for the answer to the user utterance among the searched images, and collecting may include collecting, as the conversation data, the user utterances, a query used for searching images, the images selected to be used for the answer to the user utterance, and the answer to the user utterance.

Collecting may further include: extracting characteristic information on the image from the answer to the user utterance; and adding the extracted characteristic information to the conversation data as knowledge on the image.

Collecting may further include: displaying characteristics information which is pre-labeled for the image; selecting characteristic information to reference for the answer to the user utterance from the displayed feature information; and adding the selected characteristic information on the image to the conversation data as knowledge on the image.

Collecting may further include: listing, as mentions, objects constituting an image and noun phrases constituting a text which are displayed on a chanting window which displays the user utterance and the answer to the user utterance; grouping mentions indicating the same thing among the listed mentions, and configuring the grouped mentions to an entity; and adding the entities to the conversation data as knowledge on the image.

Collecting may further include: configuring relations between the listed entities; and adding the configured relations between the entities to the conversation data as knowledge on the image.

The collected conversation data may be used for training the AI conversation model.

According to another aspect of the disclosure, there is provided a conversation data collection system including: a processor configured to search pieces of text knowledge related to a user utterance, to search images related to the user utterance, and to collect the user utterances, the pieces of text knowledge, the images, and an answer to the user utterance as conversation data; and a storage unit configured to provide a storage space necessary for the processor.

According to still another aspect of the disclosure, there is provided a conversation data generation method including: receiving input of a user utterance; searching pieces of text knowledge related to the user utterance; searching images related to the user utterance; receiving input of an answer to the user utterance referring to the searched text knowledge and images; and collecting the user utterances, the pieces of text knowledge, the images, and the answer to the user utterances as conversation data.

As described above, according to embodiments of the disclosure, open domain knowledge-based conversation data may be established by using both images and texts, and an image may be used as utterance and information acquired from the image may be used as utterance, so that AI conversation data similar to actual conversations can be implemented.

According to embodiments of the disclosure, it is possible to perform coreference resolution labeling between an image and a text, and thus it is possible to establish data which is robust to ellipsis and use of pronouns which are characteristics of the spoken language.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A to 1C are views illustrating an example of a related-art open domain knowledge-based conversation collection tool;

FIG. 2 is a view illustrating a conversation data generation system according to an embodiment of the disclosure;

FIG. 3 is a view illustrating a text knowledge selection window;

FIG. 4 is a view illustrating an image selection window;

FIG. 5 is a view illustrating an image knowledge selection window;

FIG. 6 is a view illustrating a cross-reference labeling configuration window; and

FIG. 7 is a view illustrating a detailed configuration of a data collection system.

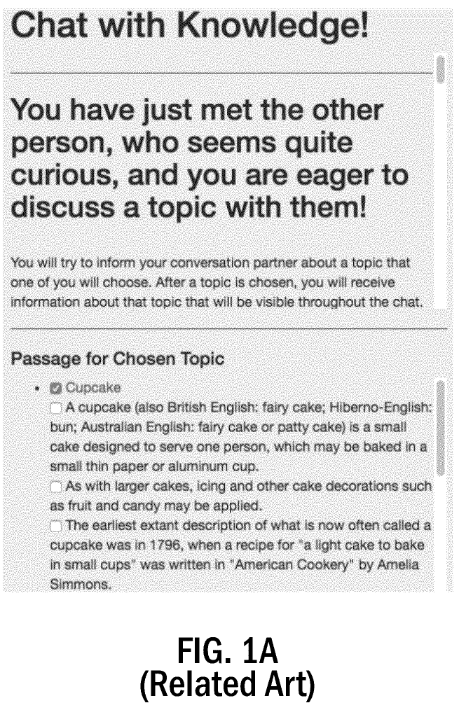

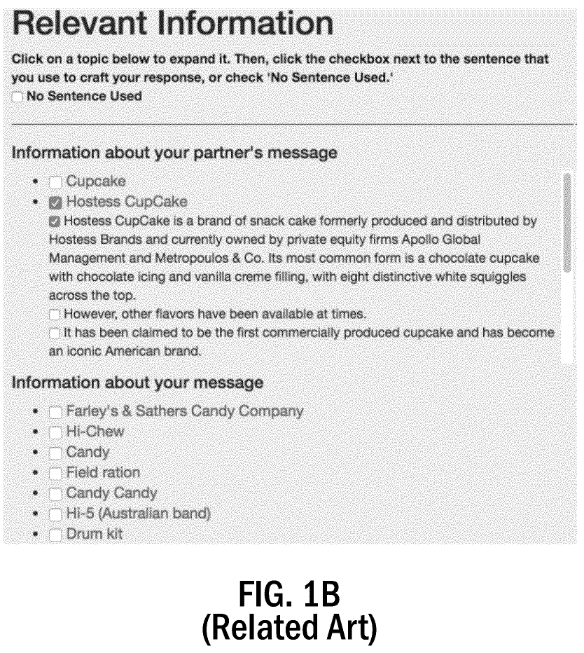

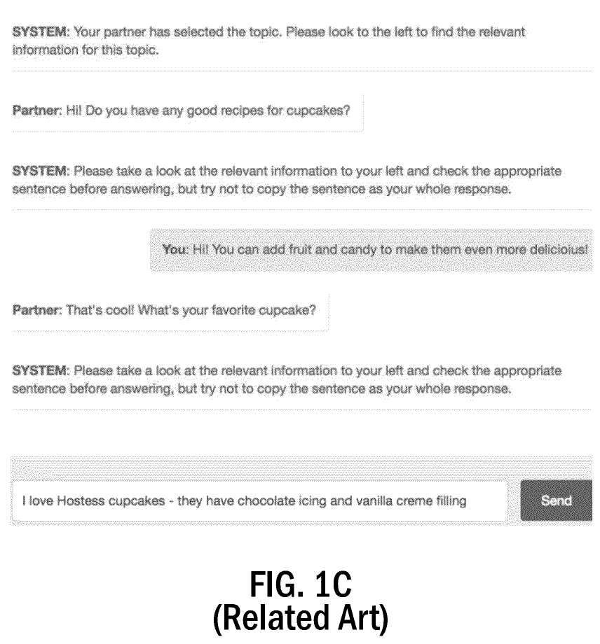

### DETAILED DESCRIPTION

Hereinafter, the disclosure will be described in more detail with reference to the accompanying drawings.

Embodiments of the disclosure provide a multi-modal knowledge-based conversation data generation and additional information labeling system.

The disclosure relates to a multi-modal open domain knowledge-based conversation collection technology which, in establishing open domain knowledge-based conversation data using both an image and a text, inputs an answer of an AI conversation model by searching images and texts, automatically labels when knowledge to reference is selected from the corresponding image and text and then is uttered, and enables coreference resolution data labeling between objects of all images in a conversation and noun phrases of an uttered text.

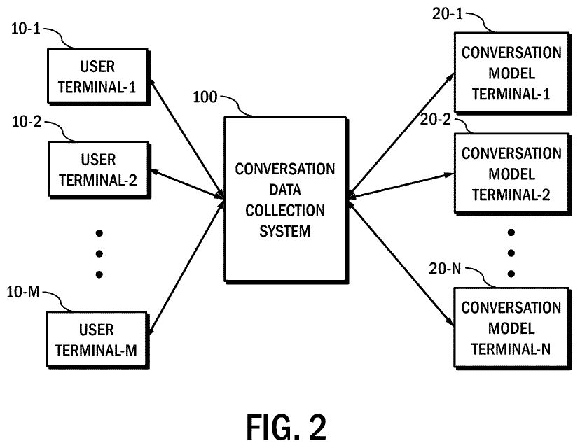

FIG. 2 is a view illustrating a configuration of a conversation data generation system for training an AI conversation model according to an embodiment of the disclosure. As shown in FIG. 2, the conversation data generation system according to an embodiment may include user terminals 10-1 10-2, . . . , 10-M, a conversation data collection system 100, and conversation model terminals 20-1, 20-2, . . . , 20-N.

The user terminals 10-1, 10-2, . . . , 10-M are terminals that are manipulated by developers and perform roles of users having conversations with an AI conversation model, and the conversation model terminals 20-1, 20-2, . . . , 20-N are terminals that are manipulated by developers and perform roles of AI conversation models answering users' conversations.

The user terminals 10-1, 10-2, . . . , 10-M and the conversation model terminals 20-1, 20-2, . . . , 20-N match each other by 1:1 and have conversations therewith. Matching may be performed manually or automatically.

In an embodiment, conversation data is generated and collected to be used as training data for an AI conversation model, and hence, the user terminals 10-1, 10-2, . . . , 10-M are manipulate by developers rather than actual users to input conversations, and the conversation model terminals 20-1, 20-2, . . . , 20-N are manipulated by developers rather than AI conversation models to input conversations.

In an embodiment, the AI conversation model may be a conversation model that supports a multi-modal knowledge-based conversation. Accordingly, when the conversation model terminals 20-1, 20-2, . . . , 20-N input conversations, the conversation model terminals 20-1, 20-2, . . . , 20-N may search texts and images and may input the same in addition to directly inputting a text.

The conversation data collection system 100 transmits conversations to the user terminals 10-1, 10-2, . . . , 10-M and the conversation model terminals 20-1, 20-1, . . . , 20-N according to a matching relationship therebetween.

In this process, the conversation data collection system 100 collects and stores conversation data which is inputted by the user terminals 10-1, 10-2, . . . , 10-M and the conversation model terminals 20-1, 20-2, . . . , 20-N. The conversation data collected in the conversation data collection system 100 is used for training the AI model conversation model.

Hereinafter, a process of collecting conversation data by the conversation data collection system 100 will be described on the assumption that one user terminal 10 representing the user terminals 10-1, 10-2, . . . , 10-M and one conversation model terminal 20 representing the conversation model terminals 20-1, 20-2, . . . , 20-N match each other and have a conversation therebetween.

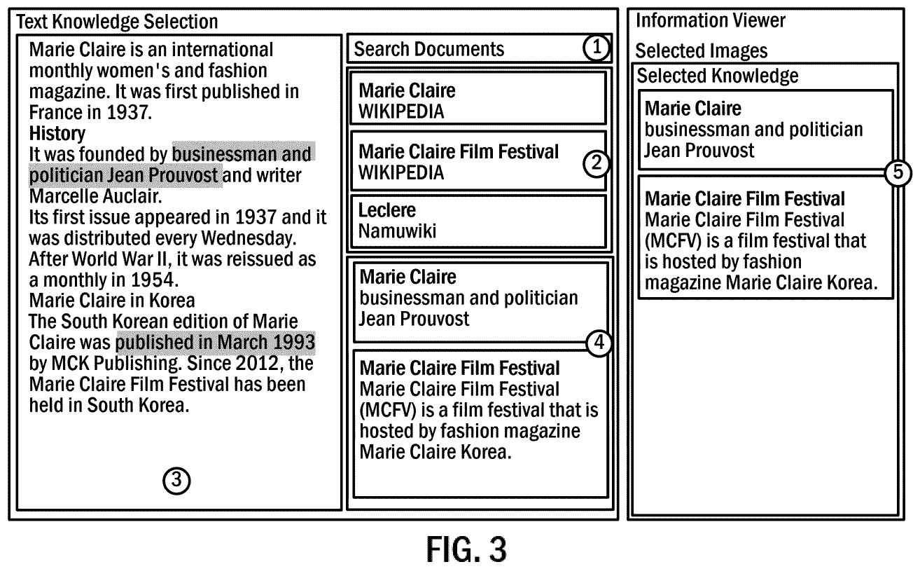

FIG. 3 is a view illustrating a ‘text knowledge selection window’ which is incidentally provided when a developer inputs an answer of the AI conversation model to the conversation model terminal 20 in response to a user utterance inputted by a developer through the user terminal 10. The text knowledge selection window is a window for selecting a piece of text knowledge to reference in generating an answer to a user utterance among pieces of text knowledge searched in relation with the user utterance, and is provided by the conversation data collection system 100 through the conversation model terminal 20.

The developer who manipulates the conversation model terminal 20 searches text documents related to the user utterance, selects some of the searched text documents, and selects a text area to reference within the selected text document through the text knowledge selection window.

As shown in FIG. 3, the text knowledge selection window may include a document search panel 1, a searched document selection panel 2, an in-document text knowledge selection panel 3, a selected text knowledge viewer 4, and a text knowledge-to-be-used as answer viewer 5.

The document search panel 1 is a panel for the developer to input a query for searching text documents related to a user utterance, and the searched document selection panel 2 is a panel for showing searched text documents and selecting a desired text document.

The in-document text knowledge selection panel 3 is a panel for showing text contents within the selected document and selecting desired text knowledge, and the selected text knowledge viewer 4 is a panel for showing text knowledge selected in the in-document text knowledge selection panel 3.

The text knowledge-to-be used as answer viewer 5 is a panel for showing text knowledge that is finally selected to reference for the answer to the user utterance among the text knowledge displayed on the selected text knowledge viewer 4.

In this process, the conversation data collection system 100 collects, as conversation data, the user utterance, the query used for searching documents, the text knowledge finally selected to reference for the answer to the user utterance, and the answer of the conversation model. The collected conversation data is used for training the AI conversation model to automatically search text knowledge from a user utterance and to use the text knowledge.

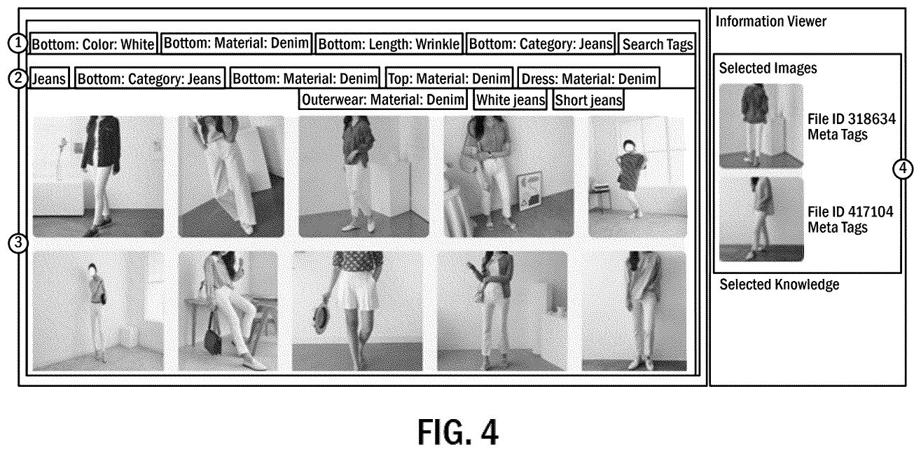

FIG. 4 is a view illustrating an ‘image selection window’ which is incidentally provided when a developer inputs an answer of the AI conversation model to the conversation model terminal 20 in response to a user utterance inputted by a developer through the user terminal 10. The image selection window is a window for selecting images to use for an answer to a user utterance among images searched in relation with the user utterance, and is provided by the conversation data collection system 100 through the conversation model terminal 20.

As shown in FIG. 4, the image selection window includes an image search panel 1, a candidate query list 2, a searched image viewer 3, and a selected image viewer 4.

The image search panel 1 is a panel for a developer to input a query for searching images related to a user utterance, and the candidate query list 2 is a panel for showing candidate queries generated for assisting in searching images.

The searched image viewer 3 is a panel for showing searched images and selecting a desired image, and the selected image viewer 4 is a panel for showing images selected in the searched image viewer 3.

In this process, the conversation data collection system 100 collects, as conversation data, the user utterance, the query used for searching images, the images selected to be used for an answer to the user utterance, and an answer of the conversation model. The collected conversation data is used for training the AI conversation model to automatically search images from a user utterance and to use the images.

The conversation data collection system 100 may extract characteristics information on an image from the answer that the developer manipulating the conversation model terminal 20 inputs by using the image, and may add the characteristic information to the conversation data as knowledge on the image.

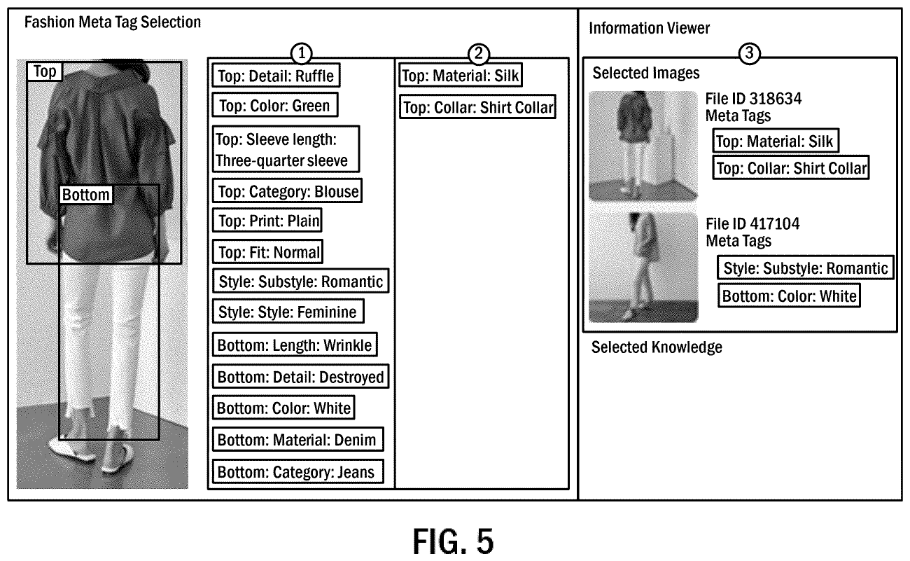

However, it may be difficult to interpret the image depending on developers, and characteristic information on the image may not be well reflected on the answer which is inputted by using the image. To compensate for this, the conversation data collection system 100 may provide an ‘image knowledge selection window’ through the conversation model terminal 20 as shown in FIG. 5. The image knowledge selection window is a window that provides characteristics information pre-labeled for an image to allow the developer manipulating the conversation model terminal 20 to select characteristic information.

As shown in FIG. 5, the image knowledge selection window includes an image characteristic panel 1, a selected image characteristic viewer 2, and a selected image knowledge panel 3.

The image characteristic panel 1 is a panel for showing characteristics information that is pre-labeled for image, the selected image characteristic viewer 2 is a panel for showing characteristic information that is selected in the image characteristic panel 1, and the selected image panel 3 is a panel for showing the selected characteristic information with the corresponding images.

The developer of the conversation model terminal 20 may input an answer to the user utterance by referring to the selected characteristic information. The conversation data collection system 100 may add the characteristic information on the image which is selected through the image knowledge selection window to the conversation data as knowledge on the image.

Furthermore, the developer of the conversation model terminal 20 may cross-reference label objects and noun phrases indicating the same entity among the objects constituting the image and the noun phrases constituting the answer in the answer using the image.

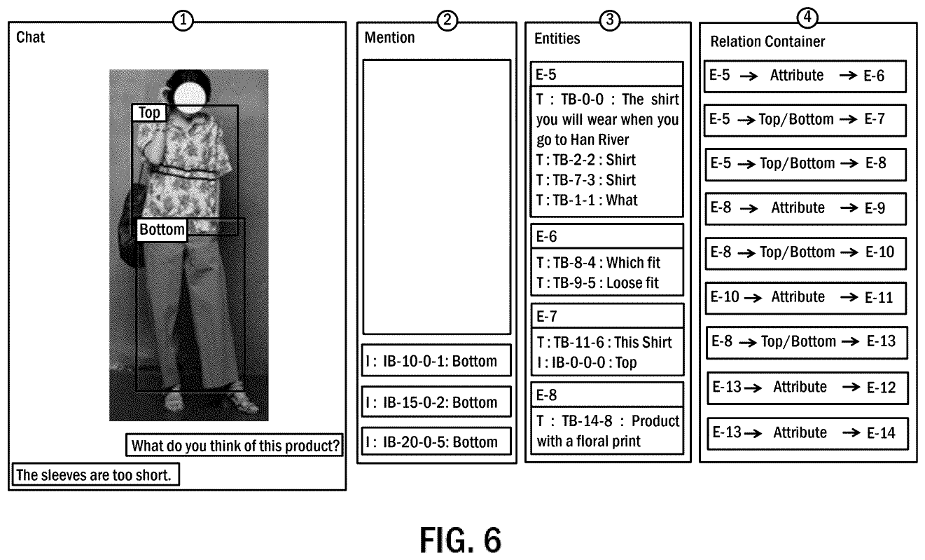

A ‘cross-reference labeling configuration window’ that the conversation data collection system 100 provides through the conversation model terminal 20 is illustrated in FIG. 6. As shown in FIG. 6, the cross-reference labeling configuration window may include a chatting window 1, a mention viewer 2, an entity viewer 3, and a relation viewer 4.

The chatting window 1 is a window that shows a user utterance inputted through the user terminal 10 and an answer of the AI conversation model inputted through the conversation model terminal 20. As described above, not only a text but also an image may be included in the answer of the AI conversation model. The mention viewer 2 lists objects constituting the image displayed on the chatting window 1, and noun phrases constituting the text as mentions.

The entity viewer 3 lists entities which group mentions indicating the same thing. When the AI conversation model says “This top is a floral pattern shirt and is good for vacation in the summer” while showing an image, the top object in the image and “this top” in the text utterance are the same mention and thus are grouped into one entity.

The relation viewer 4 shows a relation that is configured between the entities listed in the entity viewer 3.

The conversation data collection system 100 may collect entities and relation information between the entities which are configured through the cross-reference labeling configuration window as knowledge on the image.

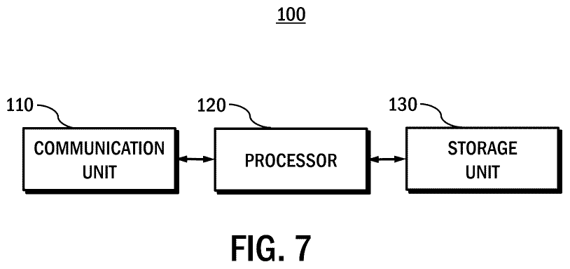

Hereinafter, a hardware configuration of the conversation data collection system 100 will be described in detail with reference to FIG. 7. FIG. 7 is a view illustrating a detailed configuration of the conversation data collection system 100 illustrated in FIG. 2.

As shown in FIG. 7, the conversation data collection system 100 may be implemented by a server system which includes a communication unit 110, a processor 120, and a storage unit 130.

The communication unit 110 is connected to communicate with the user terminals 10-1, 10-2, . . . , 10-M and the conversation model terminals 20-1, 20-1, . . . , 20-N through a network.

The processor 120 collects conversation data which is inputted by the user terminals 10-1, 10-2, . . . , 10-M and the conversation model terminals 20-1, 20-2, . . . , 20-N, and in this process, additionally collects additional information which is collected through the windows shown in FIGS. 3, 4, 5, and 6.

The storage unit 130 provides a storage space necessary for functions and operations of the processor 120, and stores the conversation data and the additional information, collected by the processor 120, as training data of the AI conversation model.

Up to now, the multi-modal knowledge-based conversation data generation and additional information labeling system has been described in detail with reference to preferred embodiments.

According to an embodiment, when knowledge to reference for an answer is selected, a user may select some of the documents directly searched and then may directly select an area of knowledge to reference in the document, and the conversation model may search not only texts but also images to use as utterance, and may select a text and an image.

In addition, when an answer is provided after an image is selected, information acquired from the image may be used. In this case, the information acquired from the image may be collected as image knowledge, and, when it is difficult to interpret the corresponding image, pre-labeled image information may be shown and an answer may be provided by using the corresponding image information.

In addition, when coreference resolution labeling is performed, cross-reference labeling is enabled between objects in an image within a conversation and noun phrases in an utterance.

Through this, open domain knowledge-based conversation data may be established by using both images and texts, and an image may be used as utterance and information acquired from the image may be used as utterance, so that AI conversation data similar to actual conversations can be established. It is possible to perform coreference resolution labeling between an image and a text, and thus it is possible to establish conversation data for training which is robust to ellipsis and use of pronouns which are characteristics of the spoken language.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A conversation data collection method comprising:
searching pieces of text knowledge related to a user utterance;
searching images related to the user utterance; and
collecting the user utterance, the pieces of text knowledge, the images, and an answer to the user utterance as conversation data.

2. The conversation data collection method of claim 1, wherein searching the pieces of text knowledge comprises:
searching text documents related to the user utterance;
selecting some of the searched text documents;
selecting some of the pieces of text knowledge within the selected text document; and
finally selecting text knowledge to reference for the answer to the user utterance among the selected pieces of text knowledge,
wherein collecting comprises collecting, as the conversation data, the user utterance, a query used for searching documents, the text knowledge finally selected to reference for the answer to the user utterance, and the answer to the user utterance.

3. The conversation data collection method of claim 2, wherein the user utterance is inputted by a developer who performs a role of a user having a conversation with an AI conversation model, and
wherein the answer to the user utterance is inputted by a developer who performs a role of the AI conversation model.

4. The conversation data collection method of claim 1, wherein searching the images comprises:
searching the images related to the user utterance; and
selecting images to use for the answer to the user utterance among the searched images,
wherein collecting comprises collecting, as the conversation data, the user utterances, a query used for searching images, the images selected to be used for the answer to the user utterance, and the answer to the user utterance.

5. The conversation data collection method of claim 4, wherein collecting further comprises:
extracting characteristic information on the image from the answer to the user utterance; and
adding the extracted characteristic information to the conversation data as knowledge on the image.

6. The conversation data collection method of claim 4, wherein collecting further comprises:
displaying characteristics information which is pre-labeled for the image;
selecting characteristic information to reference for the answer to the user utterance from the displayed feature information; and
adding the selected characteristic information on the image to the conversation data as knowledge on the image.

7. The conversation data collection method of claim 1, wherein collecting further comprises:
listing, as mentions, objects constituting an image and noun phrases constituting a text which are displayed on a chanting window which displays the user utterance and the answer to the user utterance;
grouping mentions indicating the same thing among the listed mentions, and configuring the grouped mentions to an entity; and
adding the entities to the conversation data as knowledge on the image.

8. The conversation data collection method of claim 7, wherein collecting further comprises:
configuring relations between the listed entities; and
adding the configured relations between the entities to the conversation data as knowledge on the image.

9. The conversation data collection method of claim 1, wherein the collected conversation data is used for training the AI conversation model.

10. A conversation data collection system comprising:
a processor configured to search pieces of text knowledge related to a user utterance, to search images related to the user utterance, and to collect the user utterances, the pieces of text knowledge, the images, and an answer to the user utterance as conversation data; and
a storage unit configured to provide a storage space necessary for the processor.

11. A conversation data generation method comprising:
receiving input of a user utterance;
searching pieces of text knowledge related to the user utterance;
searching images related to the user utterance;
receiving input of an answer to the user utterance referring to the searched text knowledge and images; and
collecting the user utterances, the pieces of text knowledge, the images, and the answer to the user utterances as conversation data.
